(19) United States
(12) Patent Application Publication
(10) Pub. No.: US 2025/0104039 A1
(43) Pub. Date: Mar. 27, 2025

(54) MERCHANDISE INFORMATION PROCESSING DEVICE AND MERCHANDISE INFORMATION PROCESSING METHOD

(71) Applicant: Toshiba Tec Kabushiki Kaisha, Tokyo (JP)

(72) Inventors: Tetsuya NOBUOKA, Mishima Shizuoka (JP); Shun MARUYAMA, Mishima Shizuoka (JP)

(21) Appl. No.: 18/890,550

(22) Filed: Sep. 19, 2024

(30) Foreign Application Priority Data
Sep. 26, 2023 (JP) 2023-163050

(51) Int. Cl. G06Q 20/20; G06T 7/20; G06V 20/70

(52) U.S. Cl. CPC G06Q 20/208; G06T 7/20; G06V 20/70; G06V 2201/07

(57) ABSTRACT

According to one embodiment, a merchandise information processing device includes a control unit and a communication interface connectable to a product scanner. The control unit receives an image from the product scanner. The image is obtained when a user holds a merchandise item in front of an image pickup unit of the product scanner in a scanning operation. The control unit processes the image to obtain a merchandise code for the merchandise item in the image by object recognition and may also process the image to determine if a hand of the user appears in the image. The control unit saves the image to update a dictionary file only if the merchandise code obtained by the object recognition does not match a merchandise code received from the product scanner in association with the image and the hand of the user is determined not to be in the image.

### CROSS-REFERENCE TO RELATED APPLICATION

This application is based upon and claims the benefit of priority from Japanese Patent Application No. 2023-163050, filed Sep. 26, 2023, the entire contents of which are incorporated herein by reference.

### FIELD

Embodiments described herein relate generally to a merchandise information processing device and a merchandise information processing method for use in or with point-of-sale systems for retail stores and the like.

### BACKGROUND

There is a point-of-sale system for registering a merchandise items that acquires an image of a merchandise item being held over an image pickup unit of a product scanner and reads a code on the merchandise item from the acquired image using a code recognition technique. The system thus specifies and registers the merchandise item in a sales transaction of the like based on the code that was read.

If a user or an operator holds the merchandise item over the scanner, a hand may appear in the picked-up image. If an image dictionary for an image recognition (package recognition) technique is to be generated or updated based on an image in which a hand appears, the quality of the image dictionary drops. To avoid this, a particular solution is available in which the user or the operator must take additional time and effort to avoid acquisition of images with a hand depicted therein. But this particular solution is potentially burdensome on the user/operator.

### BRIEF DESCRIPTION OF THE DRAWINGS

FIG. 1 shows an overall configuration of a merchandise information management system according to an embodiment.

FIG. 2 is a perspective view showing the external appearance of a self-service point-of-sale (POS) system.

FIG. 3 is a block diagram of a POS terminal of a POS system.

FIG. 4 is a block diagram showing the hardware configuration of a scanner of a POS system.

FIG. 5 is a block diagram of an image recognition device of a POS system.

FIG. 6 is a block diagram of a server of a POS system.

FIG. 7 shows a schematic data configuration of a merchandise master stored in a memory unit of a POS terminal.

FIG. 8 shows a schematic data configuration of a collation dictionary stored in a memory unit of an image recognition device.

FIG. 9 shows an example of image management information representing the relationship between various information on a per picked-up image basis.

FIG. 10 shows an example of ground-truth label information representing the relationship between an operation identification number and a ground-truth label.

FIG. 11 is a block diagram depicting functional aspects of a controller unit of a POS terminal.

FIG. 12 is a block diagram depicting functional aspects of a controller unit of a scanner.

FIG. 13 is a block diagram depicting functional aspects of a controller unit of an image recognition device.

FIG. 14 is a block diagram depicting functional aspects of a controller unit of a server.

FIG. 15 is a flowchart of operations of a scanner.

FIG. 16 is a flowchart of operations of an image recognition device.

FIG. 17 is a flowchart of example processing for an “operation ID assignment”.

FIG. 18 is a flowchart of example processing for an “image saving”.

FIG. 19 is a flowchart of example processing for a “ground-truth label assignment”.

### DETAILED DESCRIPTION

An embodiment described herein provides improvements to the functioning of an information processing device and an improved information processing method to enable easier generation of a high-quality dictionary for image recognition without the user or the operator of a point-of-sale system having to carry out any particular operation to curate product images for dictionary generation or updating.

In general, according to one embodiment, a merchandise information processing device has a communication interface connectable to a product scanner and a control unit. The control unit is configured to receive an image from the product scanner obtained when a user holds a merchandise item in front of an image pickup unit of the product scanner in a scanning operation; process the image to obtain a merchandise code for the merchandise item in the image by object recognition; process the image to determine if a hand of the user appears in the image; and save the image to update a dictionary file only if the merchandise code obtained by the object recognition does not match a merchandise code received from the product scanner in association with the image and the hand of the user is determined not to be in the image.

Certain example embodiments of a merchandise information processing device and a merchandise information processing method will now be described with reference to the drawings. However, the present disclosure is not limited to these example embodiments.

### Merchandise Information Management System

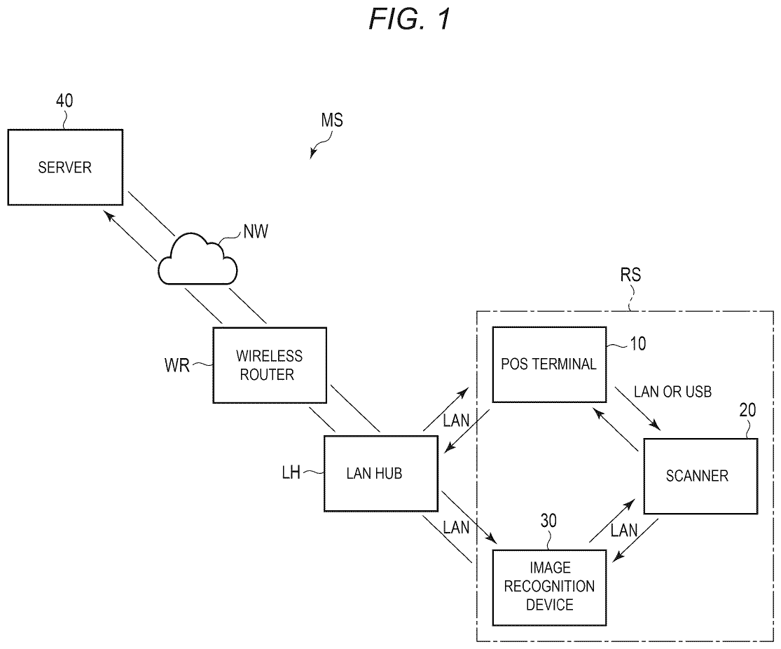

First, a merchandise information management system MS according to an embodiment will be described with reference to FIG. 1. FIG. 1 shows an overall configuration of the merchandise information management system MS. The merchandise information management system MS includes a merchandise information registration system RS and a server 40.

The merchandise information registration system RS includes a POS (point of sales) terminal 10, a scanner 20 (one example of an information processing device), and an image recognition device 30 (one example of an information processing device). The POS terminal 10 and the scanner 20 are communicably connected via a LAN (local area network) or a USB (universal serial bus). The scanner 20 and the image recognition device 30 are communicably connected via a LAN.

In this embodiment, a combination of Ethernet and TCP (transmission control protocol) can be used for LAN communication. However, the communication protocol is not limited thereto.

The POS terminal 10 and the image recognition device 30 are communicably connected to a LAN hub LH via a LAN. The LAN hub LH is communicably connected to a wireless router WR via a LAN. The wireless router WR is wirelessly communicable with the server 40 via a network NW.

The scanner 20 picks up (takes) an image of a merchandise item and thus acquires a merchandise image, which is also referred to as a picked-up image. The scanner 20 transmits the acquired merchandise image to the image recognition device 30 via the LAN. The scanner 20 also detects and decodes a merchandise barcode (e.g., a one-dimension code or two-dimensional code) when included in the acquired merchandise image. That is, the scanner 20 reads information encoded by the merchandise barcode. The result of decoding the merchandise barcode includes a merchandise code encoded by the merchandise barcode. The scanner 20 transmits the result of decoding to the image recognition device 30 via the LAN.

The image recognition device 30 receives the merchandise image (the picked-up image) from the scanner 20 via the LAN. The image recognition device 30 has, for example, an image recognition function that uses a learned model obtained based on machine learning, and performs image recognition (also referred to as “package recognition” or “object recognition”) on the merchandise image according to the image recognition function. Specifically, the image recognition device 30, by its image recognition function, acquires feature data (visual feature data) depicted in the merchandise image, collates the acquired feature data with entries in a collation dictionary (providing correspondences between various feature data values and particular merchandise codes), and acquires a merchandise code associated with feature data in the collation dictionary that is the most similar to the acquired feature data. The result of image recognition provides the merchandise code of the merchandise item depicted in the merchandise image. The image recognition device 30 may perform the image recognition on the merchandise image using a technique such as deep learning. The image recognition device 30 0 transmits the result of image recognition to the scanner 20 via the LAN.

The scanner 20 receives the image recognition result from the image recognition device 30 via the LAN. The scanner 20 can merge the decoding result with the image recognition result. To merge results in this context means to acquire one merchandise code when the decoding result and the image recognition result differ. That is, the result of merging will be based on the merchandise barcode included in the merchandise image or the merchandise code obtained by image recognition on the merchandise image. The scanner 20 transmits the result of merging to the POS terminal 10 via the LAN or via the USB. The POS terminal 10 performs merchandise registration based on the merchandise code provided as the result of merging from the scanner 20.

The image recognition device 30 decides whether to use the merchandise image received from the scanner 20 for additional learning. For example, if the difference between the acquired feature data and the feature data that is the most similar to the acquired feature data is equal to or greater than some predetermined amount, the image recognition device 30 determines that the merchandise image received from the scanner 20 is to be used for additional learning. The image recognition device 30 thus transmits the merchandise image to be used for additional learning along with the decoded merchandise code received from the scanner 20 to the server 40 via the LAN.

The server 40 receives the merchandise image and merchandise code from the image recognition device 30 via the LAN. The server 40 collects and stores the merchandise image and the merchandise code in correlation with each other. The server 40 performs additional learning for the learned model for merchandise image recognition using the merchandise image and the merchandise code that were collected and stored. The server 40 updates the learned model after the additional learning. The server 40 also updates the collation dictionary after to the additional learning. In this context, an update of the collation dictionary can be a modification of an existing record and/or an addition of a new record. The server 40 transmits the updated learned model and the updated collation dictionary to the image recognition device 30 via the LAN.

The image recognition device 30 receives the updated learned model and the updated collation dictionary from the server 40 via the LAN. The image recognition device 30 updates the currently held (stored) learned model with the updated learned model that was just received. The image recognition device 30 also updates the currently held (stored) collation dictionary with the updated collation dictionary that was just received.

In this merchandise information management system MS, if the package (packaging) of a merchandise item is changed, the time and effort of manually collecting a new merchandise image(s) for additional learning for merchandise image recognition can be avoided.

The server 40 manages a merchandise master. The POS terminal 10 transmits payment processing information (information about a transaction for which payment processing is done) to the wireless router WR via the LAN and the LAN hub LH. The wireless router WR transmits the received payment processing information to the server 40 via the network NW. The server 40 manages the merchandise master, based on the received payment processing information. For example, the server 40 receives payment processing information from a plurality of POS terminals 10 and manages a merchandise master on a per POS terminal 10 basis, of the plurality of POS terminals 10. The management of the merchandise master includes a modification of an existing record and/or an addition of a new record. The server 40 also transmits, to each POS terminal 10, the merchandise master suitable for the POS terminal 10 via the network NW, the wireless router WR, and the LAN hub LH.

The image recognition device 30 may transmit the merchandise image received from the scanner 20 to the server 40 regardless of whether to use the merchandise image for additional learning. In this case, the merchandise image collected and stored in the server 40 may be used, for example, to analyze the state (event) of image recognition at the image recognition device 30, or the like.

### Merchandise Information Registration System

As an example of a merchandise information registration system, a self-service POS system that a customer purchasing a merchandise item operates by himself or herself will now be described. However, the merchandise information registration system is not limited to a self-service POS system. The merchandise information registration system may be a POS system that a store clerk at a store selling a merchandise item operates.

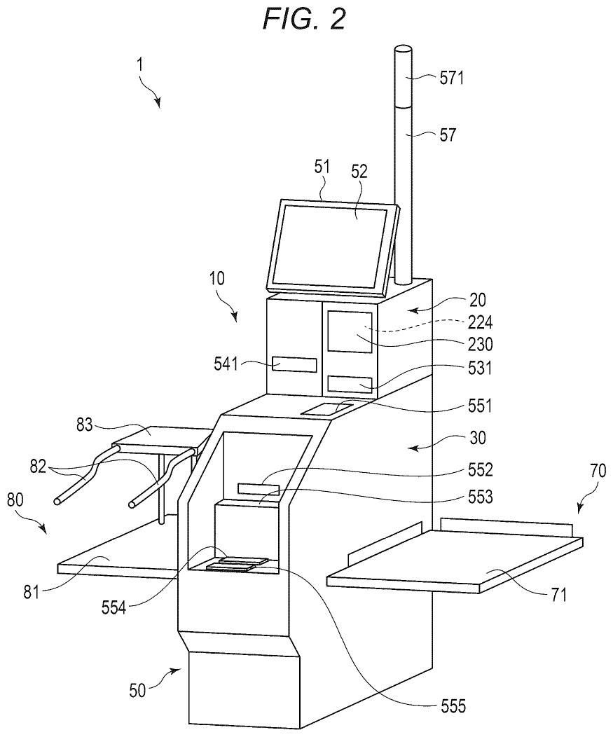

FIG. 2 is a perspective view showing the external appearance of a self-service POS system 1. The self-service POS system 1 includes the POS terminal 10, the scanner 20 built in the POS terminal 10, and the image recognition device 30 built in the POS terminal 10. The self-service POS system 1 is an example of a merchandise information registration system. The POS terminal 10 is an example of a registration device. The scanner 20 and the image recognition device 30 are each an example of an information processing device.

The scanner 20 identifies a merchandise item being purchased by a customer and transmits the merchandise code of the merchandise item to the POS terminal 10. The merchandise code is an example of merchandise identification information and can be any information that identifies the merchandise item. The POS terminal 10 executes merchandise registration based on the merchandise code from the scanner 20 and then executes payment processing for the registered merchandise item(s). The payment processing is executed by the POS terminal 10 so the customer can pay the purchase price of the merchandise item.

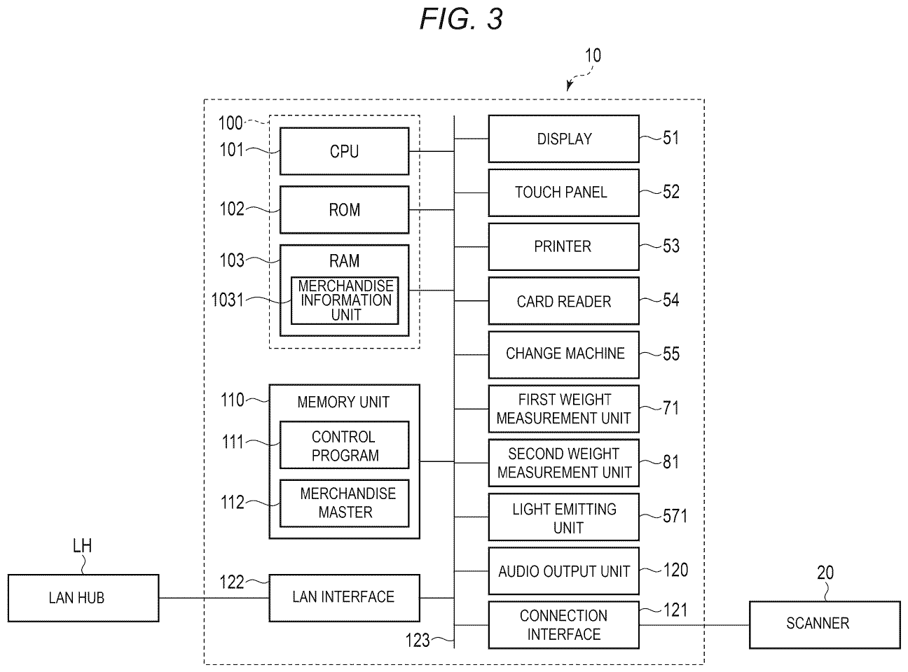

As shown in FIG. 2, the POS terminal 10 has a main body 50, a first placing table 70, and a second placing table 80. The main body 50 has a display 51 and a touch panel 52 at an upper part and contains a printer 53, a card reader 54, and a change machine 55 (see FIG. 3 for each of these components) inside.

The display 51 is a display device such as an LCD (liquid crystal display) and displays various information. For example, the display 51 displays merchandise information such as the merchandise name and the price of a merchandise item registered by a registration operation performed by the customer. The display 51 also displays payment information such as the total amount and the amount of change in a transaction in response to a payment operation performed by the customer.

The touch panel 52 is provided on the surface of the display 51 and sends information corresponding to a touched position to a controller unit 100 (see FIG. 3) of the POS terminal 10. A customer or a clerk (each of whom can be a user and operator) using the POS terminal 10 can operate the touch panel 52 by touching various buttons and an operation key displayed on the display 51.

As shown in FIG. 2, a reading window 230 of the scanner 20, a dispensing port 531 for a receipt printed by the printer 53, and a card insertion port 541 of the card reader 54 are formed below the display 51, facing the direction where the customer is located.

The reading window 230 is a window provided for the scanner 20 to image (e.g., photograph) the external appearance of a merchandise item. The customer operating the self-service POS system 1 holds a merchandise item to be purchased over the reading window 230 and thus performs an operation for merchandise registration. Generally, the customer holds the merchandise item over the reading window 230 while changing its orientation in relation to the reading window 230 until the self-service POS system 1 executes a merchandise registration and generates a registration completion sound or the like.

The dispensing port 531 is an opening for discharge of a receipt printed by the printer 53. On the receipt, information about a transaction performed at the POS terminal 10 (payment processing information) is printed. The POS terminal 10 may be set to dispense an electronic receipt instead of a paper receipt.

The card insertion port 541 is an opening to insert a credit card to be read by the card reader 54. When the customer makes a payment by credit card or when the customer causes a store membership card or the like to be read, the customer inserts the card from the card insertion port 541.

In the main body 50, a coin insertion port 551, a coin discharge port 552, a coin tray 553, a bill insertion port 554, and a bill discharge port 555 are formed corresponding to the position of the change machine 55 contained inside.

The coin insertion port 551 is an opening for the customer to insert a coin for payment. The coin inserted in the coin insertion port 551 is contained in the change machine 55. The coin discharge port 552 is an opening to discharge a coin withdrawn from the change machine 55. The coin discharge port 552 discharges a coin for the change or a coin that is inserted from the coin insertion port 551 but is not accepted by the change machine 55. The coin tray 553 is a tray that receives a coin discharged from the coin discharge port 552. The bill insertion port 554 is an opening for the customer to insert a bill for payment. The bill inserted in the bill insertion port 554 is contained in the change machine 55. The bill discharge port 555 is an opening to discharge a bill for the change withdrawn from the change machine 55.

The first placing table 70 is where a shopping basket or the like containing a merchandise item to be purchased can be placed. The first placing table 70 has a first weight measurement unit 71. The first weight measurement unit 71 measures the total weight of the shopping basket placed on the first basket placing table 70 and the merchandise item contained in the shopping basket.

The second placing table 80 is place for temporarily storing a merchandise item which has been taken out of the shopping basket on the first placing table 70 and then registered (that is, a registered merchandise item). The second placing table 80 has a second weight measurement unit 81, a pair of support rods 82, and a temporary placing table 83.

The second weight measurement unit 81 measures the total weight of items on the second placing table 80 or the total weight of items in a shopping bag supported by the pair of support rods 82. The support rods 82 are hooks or the like to support a shopping bag containing a registered merchandise item. The support rods 82 support the shopping bag in an open state and thus make it easier to put items into the shopping bag. The temporary placing table 83 is where fragile or deformable merchandise items (for example, tofu or eggs) can be temporarily placed before packing or the like after being registered. The customer eventually places the items on the temporary placing table 83 into a shopping basket or shopping bag to leave the store.

The customer holds a merchandise item taken out of the shopping basket placed on the first placing table 70 over the reading window 230, and thus performs merchandise registration. The customer then puts the registered merchandise item on the second placing table 80 or into a shopping bag supported by the support rods 82. Another shopping basket may be placed on the second placing table 80 in some instances.

Since the first weight measurement unit 71 measures the weight before and after a merchandise item is taken out of the shopping basket on the first placing table 70, the controller unit 100 (see FIG. 3) can recognize a change in weight. The second weight measurement unit 81 also measures the weight before and after a merchandise item is on the second placing table 80 or into a shopping bag supported by the support rods 82, thus the controller unit 100 recognizes a change in weight at the second placing table 80. Based on whether the two changes in weight are equal, the controller unit 100 can determine whether all the merchandise items to be purchased by the customer have been registered.

The main body 50 also has a circular cylindrical pole 57 extending upward. A light emitting unit 571 that emits light to call a store clerk (also referred to as a manager of the POS terminal 10) is provided at an upper end part of the pole 57. Hardware Configuration of POS Terminal

FIG. 3 is a block diagram showing a hardware configuration of the POS terminal 10.

The POS terminal 10 has a controller unit 100, a memory unit 110, a display 51, a touch panel 52, a printer 53, a card reader 54, a change machine 55, a first weight measurement unit 71, a second weight measurement unit 81, a light emitting unit 571, an audio output unit 120, a connection interface 121, and a LAN interface 122. The controller unit 100, the memory unit 110, the display 51, the touch panel 52, the printer 53, the card reader 54, change machine 55, the first weight measurement unit 71, the second weight measurement unit 81, the light emitting unit 571, the audio output unit 120, the connection interface 121, and the LAN interface 122 are coupled to each other via a bus 123 or the like.

The controller unit 100 can be a computer having a CPU (central processing unit) 101, a ROM (read-only memory) 102, and a RAM (random access memory) 103. The CPU 101, the ROM 102, and the RAM 103 are coupled to each other via the bus 123.

The CPU 101 controls the POS terminal 10. The ROM 102 stores various programs such as a program used to drive the CPU 101, and various data. The RAM 103 is used as a work area of the CPU 101. Various programs and various data stored in the ROM 102 and the memory unit 110 are loaded in the RAM 103. For example, as the CPU 101 operates according to a control program 111 stored in the memory unit 110 and loaded in the RAM 103, the controller unit 100 executes various control processing of the POS terminal 10.

The RAM 103 has a merchandise information unit 1031. The merchandise information unit 1031 stores merchandise information read out from a merchandise master 112, described later, based on a merchandise code acquired from the scanner 20. As the merchandise information is stored (registered) in the merchandise information unit 1031, merchandise registration is performed. The merchandise information stored in the merchandise information unit 1031 is the merchandise code, the merchandise name, the price, and the like. The merchandise information unit 1031 stores merchandise information about one transaction and is cleared on completion of the payment processing for the one transaction.

The memory unit 110 can be an HDD (hard disk drive) or a flash memory and maintains the stored content even if the power is shut off. The memory unit 110 stores the control program 111 and the merchandise master 112.

The control program 111 is a software program or the like to implement the function of receiving a merchandise code from the scanner 20, the function of executing merchandise registration based on the received merchandise code, the function of executing payment processing for the registered merchandise item, the function of executing the setting of various operation modes in the merchandise information registration system RS in response to an operation by a manager, and the like. The control program 111 may be stored in the ROM 102 instead of being stored in the memory unit 110.

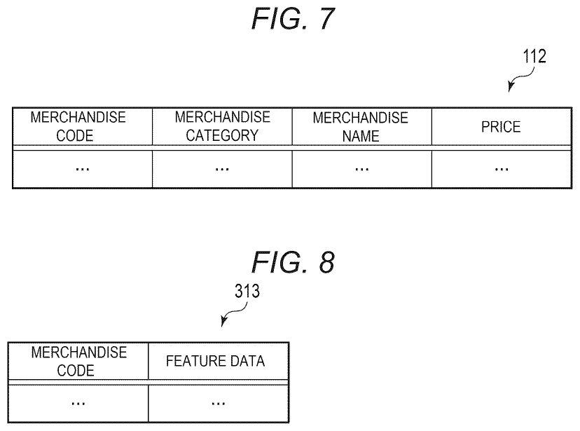

The merchandise master 112 is a master file storing merchandise information about merchandise items available at the store. Since merchandise items available at the store vary day by day, the merchandise master 112 may be suitably updated by a store server or the like connected via the LAN interface 122. FIG. 7 shows the data configuration of the merchandise master 112. The merchandise master 112 includes a merchandise code and a merchandise category, merchandise a name and a price corresponding to the merchandise code.

The merchandise code is information particularly identifying a merchandise item. The merchandise category is information categorizing or grouping merchandise items available for sale at the store. The merchandise name is information indicating the name of a merchandise item. The price is information indicating the price (unit price) of a merchandise item. The merchandise master 112 may include other additional information in correlation with the merchandise code.

Referring back to FIG. 3, the description of the hardware configuration of the POS terminal 10 continues. The configurations and functions of the display 51 and the touch panel 52 are as described above.

The printer 53 is, for example, a thermal printer. The printer 53 prints information or the like about a transaction on a rolled receipt paper and dispenses the paper as a receipt from the dispensing port 531.

The card reader 54 reads necessary credit information for settlement from a credit card inserted from the card insertion port 541. The card reader 54 also reads member information specifying a member from a medium such as a membership card or a point card inserted from the card insertion port 541. The card reader 54 may be configured to magnetically read information from a card or may be an IC card reader that reads information from an IC card with a built-in IC (integrated circuit).

The change machine 55 accepts bills and coins which the customer pays when paying the purchase price of a merchandise item by cash. The change machine 55 returns the change according to need. The bills are inserted from the bill insertion port 554. The coins are inserted from the coin insertion port 551. The bills for the change are discharged from the bill discharge port 555. The coins for the change are discharged from the coin discharge port 552.

The configurations and functions of the first weight measurement unit 71, the second weight measurement unit 81, and the light emitting unit 571 are as described above. The audio output unit 120 generates a sound according to need and thus notifies the customer of information. For example, the audio output unit 120 outputs a reporting sound reporting that a merchandise registration has been complete. The audio output unit is an example of a reporting unit.

The connection interface 121 is an interface to communicate with the scanner 20 via the LAN or the USB. The controller unit 100 transmits and receives information (data) to and from the scanner 20 via the connection interface 121 and via the LAN or the USB. For example, the controller unit 100 receives a merchandise code from the scanner 20 via the connection interface 121 and via the LAN or the USB. Also, for example, the controller unit 100 transmits data of an operation mode selected in response to an operation by the manager, to the scanner 20 via the connection interface 121 and via the LAN or the USB.

The LAN interface 122 is an interface to communicate with the LAN hub LH via the LAN. The controller unit 100 transmits and receives information (data) to and from the LAN hub LH via the LAN interface 122 and via the LAN. For example, the controller unit 100 transmits and receives the merchandise master 112 to and from the server 40 via the LAN hub LH and the wireless router WR and via the LAN.

The LAN interface 122 is also an interface to communication with an external device such as a store server, not illustrated, that is managed by the store. The controller unit 100 transmits and receives information to and from the external device via the LAN interface 122 and the LAN.

### Hardware Configuration of Scanner

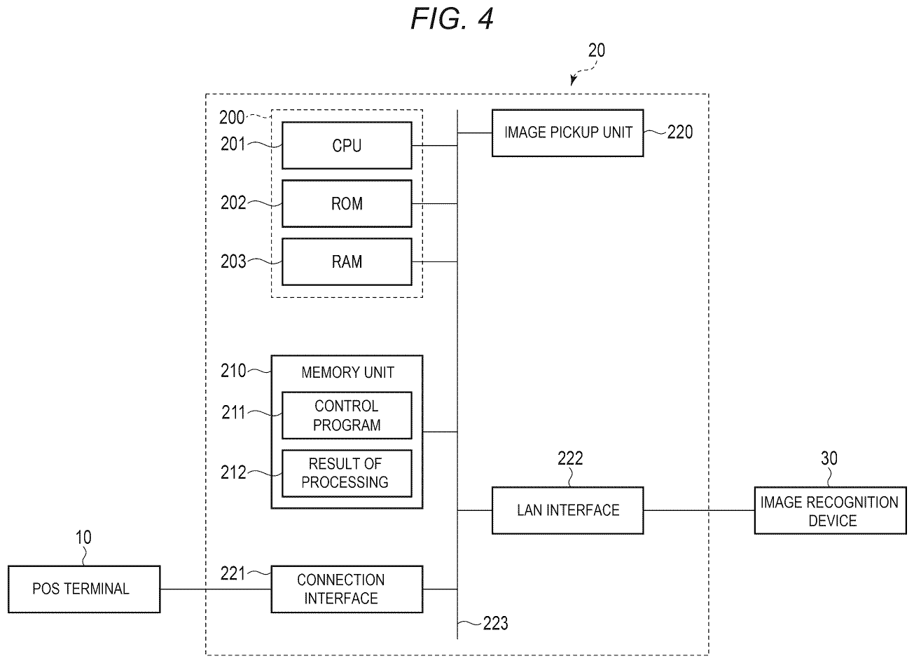

FIG. 4 shows a hardware configuration of the scanner 20.

The scanner 20 picks up an image of a merchandise item to be purchased by the customer and acquires a merchandise image, which is a picked-up image. Subsequently, the scanner 20 detects a merchandise barcode included in the merchandise image, that is, a barcode attached to the merchandise picked up in the image, and decodes the detected merchandise barcode. The result of decoding the merchandise barcode includes a merchandise code held by the merchandise barcode. The scanner 20 also transmits the merchandise image to the image recognition device 30 via the LAN.

The scanner 20 has a controller unit 200, a memory unit 210, an image pickup unit 220, a connection interface 221, and a LAN interface 222. The controller unit 200, the memory unit 210, the image pickup unit 220, the connection interface 221, and the LAN interface 222 are coupled to each other via a bus 223 or the like.

The controller unit 200 can be a computer having a CPU 201, a ROM 202, and a RAM 203. The CPU 201, the ROM 202, and the RAM 203 are coupled to each other via the bus 223.

The CPU 201 controls the scanner 20. The ROM 202 stores various programs such as a program used to drive the CPU 201, and various data. The RAM 203 is used as a work area of the CPU 201. Various programs and various data stored in the ROM 202 and the memory unit 210 are loaded in the RAM 203. For example, as the CPU 201 operates according to a control program 211 stored in the memory unit 210 and loaded in the RAM 203, the controller unit 200 executes various control processing of the scanner 20.

The memory unit 210 can be an HDD or a flash memory and maintains the stored content even if the power is shut off. The memory unit 210 stores the control program 211 and a result of processing 212.

The control program 211 provides instructions to implement a function of starting the image pickup by the image pickup unit 220 in response to the reception of a transaction start signal from the POS terminal 10, a function of saving, in the RAM 203, a frame image (picked-up image) of a merchandise image picked up by the image pickup unit 220, a function of acquiring the frame image (merchandise image, which is the picked-up image) held in the RAM 203, a function of detecting the merchandise barcode included in the merchandise image, a function of decoding the merchandise barcode, a function of transmitting the merchandise image to the image recognition device 30, a function of receiving the result of image recognition from the image recognition device 30, a function of merging the result of decoding with the result of image recognition, a function of transmitting the merchandise code that is the result of merging to the POS terminal 10, a function of stopping the image pickup by the image pickup unit 220 in response to the reception of a registration completion signal from the POS terminal 10, and the like. The control program 211 may be stored in the ROM 202 instead of being stored in the memory unit 210.

The result of processing 212 includes the result of decoding the merchandise barcode, the result of image recognition by the image recognition device 30, and the result of merging the result of decoding with the result of image recognition. The result of merging includes the merchandise barcode included in the merchandise image or the merchandise code of the merchandise item appearing in the merchandise image.

The image pickup unit 220 is, for example, a color CCD image sensor, a color CMOS image sensor or the like. The image pickup unit 220 picks up an image of a merchandise item through the reading window 230 and outputs a merchandise image, which is the acquired picked-up image, under the control of the controller unit 200. For example, the image pickup unit 220 performs image pickup of a dynamic image with a predetermined frame rate (for example, 30 fps). The image pickup unit 220 sequentially saves the picked-up frame image in the RAM 203. The frame image (merchandise image) held in the RAM 203 is used to specify the merchandise code of the merchandise item appearing in the frame image.

The connection interface 221 is an interface to communicate with the POS terminal 10 via the LAN or the USB. The controller unit 200 transmits and receives information (data) to and from the POS terminal 10 via the connection interface 221 and via the LAN or the USB.

The LAN interface 222 is an interface to communicate with the image recognition device 30 via the LAN. The controller unit 200 transmits and receives information (data) to and from the image recognition device 30 via the LAN interface 222 and via the LAN.

The controller unit 200 detects the merchandise barcode included in the frame image (merchandise image) held in the RAM 203, decodes the merchandise barcode, and acquires the merchandise code held by the merchandise barcode. The controller unit 200 also transmits the frame image (merchandise image) held in the RAM 203 to the image recognition device 30 and receives the result of image recognition by the image recognition device 30 (merchandise code) from the image recognition device 30, via the LAN interface 222. The controller unit 200 also merges the result of decoding with the result of image recognition, specifies the merchandise barcode included in the merchandise image or the merchandise code of the merchandise item appearing in the merchandise image, and transmits the specified merchandise code to the POS terminal 10 via the connection interface 221. Hardware Configuration of Image Recognition Device

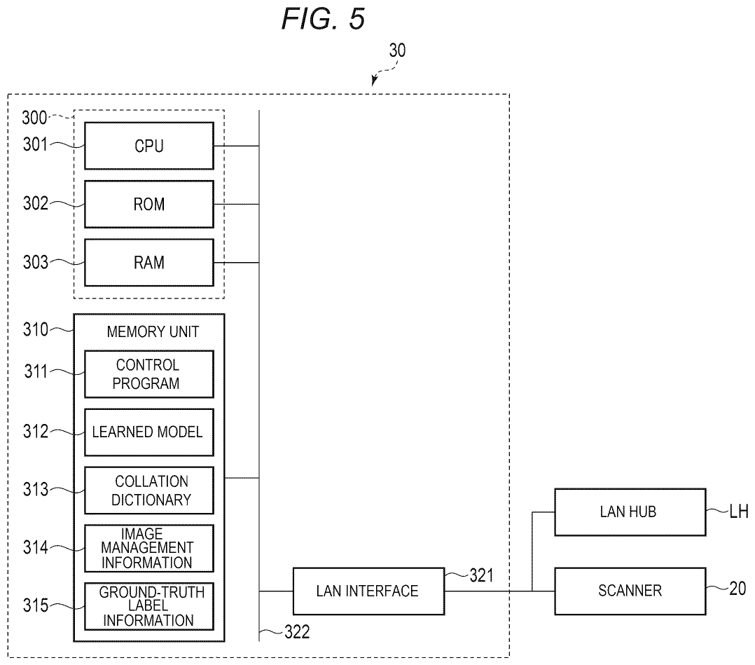

FIG. 5 shows a hardware configuration of the image recognition device 30.

The image recognition device 30 receives a merchandise image (picked-up image) from the scanner 20 via the LAN. The image recognition device 30 starts image recognition in response to the reception of the picked-up image from the scanner 20, and stops image recognition once picked-up images are no longer being received from the scanner 20. The image recognition device 30 performs image recognition on the merchandise images included in the received picked-up images. That is, the image recognition device 30 acquires the merchandise code of the merchandise items appearing in the merchandise images based on the feature data obtained from a merchandise image. The image recognition device 30 transmits the image recognition result to the scanner 20 via the LAN. The image recognition device 30 also transmits the merchandise image (or the merchandise image and the merchandise code, when available) to the server 40 via the LAN at various points or upon request. The image recognition device 30 also receives the updated learned model and collation dictionary from the server 40 via the LAN and updates the currently held learned model and collation dictionary.

The image recognition device 30 has a controller unit 300, a memory unit 310, and a LAN interface 321. The controller unit 300, the memory unit 310, and the LAN interface 321 are coupled to each other via a bus 322 or the like.

The controller unit 300 can be a computer having a CPU 301, a ROM 302, and a RAM 303. The CPU 301, the ROM 302, and the RAM 303 are coupled to each other via the bus 322.

The CPU 301 controls the image recognition device 30. The ROM 302 stores various programs such as a program used to drive the CPU 301, and various data. The RAM 303 is used as a work area of the CPU 301. Various programs and various data stored in the ROM 302 and the memory unit 310 are loaded in the RAM 303. For example, as the CPU 301 operates according to a control program 311 stored in the memory unit 310 and loaded in the RAM 303, the controller unit 300 executes various control processing of the image recognition device 30.

The memory unit 310 can be an HDD or a flash memory and maintains the stored content even if the power is shut off. The memory unit 310 stores the control program 311, a learned model 312, a collation dictionary 313, image management information 314, and ground-truth label information 315.

The control program 311 provides instructions to implement a function of receiving the merchandise image, which is the piked-up image from the scanner 20, a function of performing image recognition on the merchandise image, a function of determining whether image recognition is successful, a function of transmitting the result of image recognition to the scanner 20, a function of receiving the merchandise code that is the result of decoding from the scanner 20, a function of determining whether to use the merchandise image for additional learning, a function of transmitting the merchandise image, or the merchandise image and the merchandise code, to the server 40, a function of receiving the updated learned model and the updated collation dictionary from the server 40, a function of updating the currently held learned model with the updated learned model, a function of updating the currently held collation dictionary with the updated collation dictionary, and the like. The control program 311 may be stored in the ROM 302 instead of being stored in the memory unit 310.

The learned model 312 is an image recognition model to perform image recognition on the merchandise image. The learned model 312 is already learned by machine learning and is additionally learned by machine learning.

The collation dictionary 313 is a data table that manages a merchandise item and feature data of the external appearance of the merchandise item in correlation with each other. FIG. 8 shows the data configuration of the collation dictionary 313. The collation dictionary 313 includes a merchandise code and feature data corresponding to the merchandise code. The collation dictionary 313 may have a plurality of feature data corresponding to one merchandise code. The merchandise code in the collation dictionary 313 is the same as the merchandise code in the merchandise master 112 held in the memory unit 110 of the POS terminal 10.

As described above, the merchandise code is information identifying a merchandise item. The feature data represents a feature of the external appearance of a merchandise item, for example, the standard shape of the merchandise, the color tone, pattern, irregularity or the like of the surface, and the like, in the form of a parameter. The controller unit 300 acquires the feature data included in the merchandise image, collates the acquired feature data with the collation dictionary, and acquires the merchandise code corresponding to the acquired feature data. In other words, the controller unit 300 acquires the merchandise code of the merchandise item appearing in the merchandise image from among merchandise items recorded in advance in the collation dictionary 313, based on the feature data acquired from the merchandise image.

The image management information 314 is information generated by a control unit 3006, described later. Details of the image management information 314 will be described later.

The ground-truth label information 315 is information generated by the control unit 3006, described later. Details of the ground-truth label information 315 will be described later.

Referring back to FIG. 5, the description of the hardware configuration of the image recognition device 30 continues.

The LAN interface 321 is an interface to communicate with the scanner 20 and the LAN hub LH. The controller unit 300 transmits and receives information (data) to and from the scanner 20 and the LAN hub LH via the LAN interface 321.

For example, the controller unit 300 receives a frame image (merchandise image) from the scanner 20 via the LAN interface 321. The controller unit 300 also acquires the merchandise code of the merchandise item appearing in the merchandise image, as described above, and transmits the acquired merchandise code to the scanner 20 via the LAN interface 321.

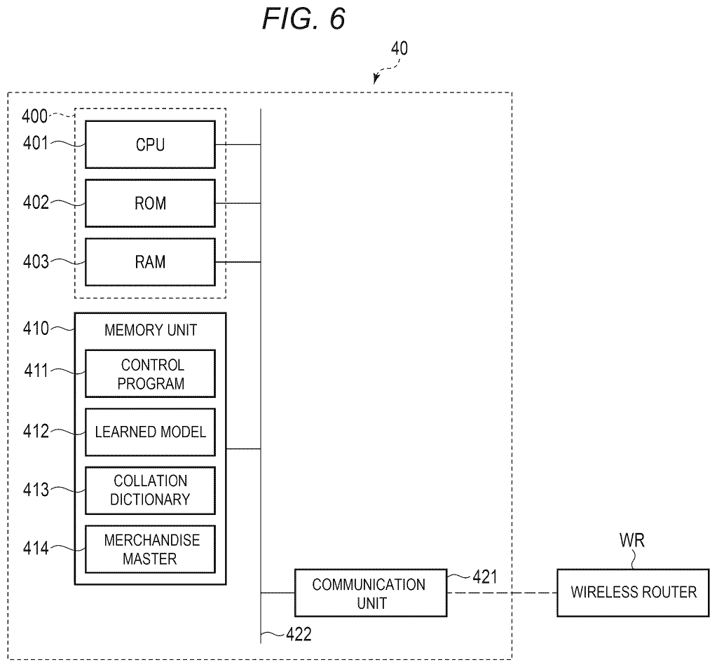

The controller unit 300 also transmits the merchandise image on which image recognition is performed, or the merchandise image on which image recognition is performed and the merchandise code that is the result of decoding received from the scanner 20, to the server 40 via the LAN interface 321 according to need. The controller unit 300 also receives an updated learned model 412 (see FIG. 6) and an updated collation dictionary 413 (see FIG. 6) from the server 40 via the LAN interface 321. The controller unit 300 updates the currently held learned model 312 with the updated learned model 412. The controller unit 300 also updates the currently held collation dictionary 313 with the updated collation dictionary 413.

### Hardware Configuration of Server

FIG. 6 shows a hardware configuration of the server 40.

The server 40 receives, collects and stores the merchandise image and the merchandise code from the image recognition device 30. The server 40 performs additional learning of the learned model for merchandise image recognition, using the merchandise image and the merchandise code that are collected and stored, and thus updates the learned model and the collation dictionary. The server 40 transmits the updated learned model and the updated collation dictionary to the image recognition device 30. The server 40 also manages a merchandise master. The server 40 receives payment processing information from the POS terminal 10 and manages the merchandise master, based on the received payment processing information. The server 40 transmits, to each POS terminal 10, the merchandise master suitable for the POS terminal 10.

The server 40 has a controller unit 400, a memory unit 410, and a communication unit 421. The controller unit 400, the memory unit 410, and the communication unit 421 are coupled to each other via a bus 422 or the like.

The controller unit 400 can be a computer having a CPU 401, a ROM 402, and a RAM 403. The CPU 401, the ROM 402, and the RAM 403 are coupled to each other via the bus 422.

The CPU 401 controls the server 40. The ROM 402 stores various programs such as a program used to drive the CPU 401, and various data. The RAM 403 is used as a work area of the CPU 401. Various programs and various data stored in the ROM 402 and the memory unit 410 are loaded in the RAM 403. For example, as the CPU 401 operates according to a control program 411 stored in the memory unit 410 and loaded in the RAM 403, the controller unit 400 executes various control processing of the server 40.

The memory unit 410 can be an HDD or a flash memory and maintains the stored content even if the power is shut off. The memory unit 410 stores the control program 411, the learned model 412, the collation dictionary 413, and a merchandise master 414.

The control program 411 provides instructions to implement functions for receiving the merchandise image and the merchandise code from the image recognition device 30, collecting and storing the merchandise image and the merchandise code, performing additional learning and updating the learned model 412, updating the collation dictionary 413, transmitting the updated learned model 412 and the updated collation dictionary 413 to the image recognition device 30, receiving the payment processing information from the POS terminal 10, managing the merchandise master 414, transmitting the merchandise master 414 to the POS terminal 10, transmitting the collected and stored merchandise image to an external device according to need or request, and the like. The control program 411 may be stored in the ROM 402 instead of being stored in the memory unit 410.

The learned model 412 is a model established by machine learning to perform image (object) recognition on merchandise images. Specifically, the learned model 412 is an image recognition model that acquires feature data from a merchandise image, compares the acquired feature data with entries in the collation dictionary 413, and thus acquires a merchandise code of the merchandise item in the merchandise image.

The collation dictionary 413 is a data table for associating the merchandise code of a merchandise item to feature data corresponding to the external appearance of the merchandise item, similarly to the collation dictionary 313 held by the image recognition device 30. The collation dictionary 413 may comprise the individual collation dictionaries 313 held by a plurality of different image recognition devices 30. The server 40 transmits, to each image recognition device 30, the collation dictionary 313 suitable for the particular image recognition device 30.

The merchandise master 414 includes entries for individual merchandise codes, with each merchandise code being associated with a merchandise category, a merchandise name, and a price, similarly to the merchandise master 112 held by the POS terminal 10. The merchandise master 414 can comprise merchandise masters 112 held by a plurality of different POS terminals 10. The server 40 manages the merchandise master 414 based on the payment processing information received from the POS terminal 10. For example, the server 40 updates the merchandise master 414 based on the payment processing information. The server 40 transmits, to each POS terminal 10, the merchandise master 112 suitable for the particular POS terminal 10.

The communication unit 421 is an interface to communicate with the wireless router WR. The controller unit 400 transmits and receives information (data) to and from the wireless router WR via the communication unit 421.

For example, the controller unit receives, collects, and stores the merchandise images and the results of image recognition from the image recognition device 30 via the communication unit 421. The controller unit 400 performs additional learning for the learned model 412 using the merchandise images and the results of image recognition that have been collected and stored, and thus updates the learned model 412 and the collation dictionary 413 as appropriate. The controller unit 400 transmits the updated learned model and the updated collation dictionary to the image recognition device 30 via the communication unit 421. The controller unit 400 may transmit the collected and stored merchandise images to an external device according to need.

The server 40 also receives the payment processing information from the POS terminal 10 via the communication unit 421. The server 40 manages the merchandise master, based on the received payment processing information. The server 40 transmits, to each POS terminal 10, the merchandise master suitable for the POS terminal 10 via the communication unit 421.

### Functional Aspects of POS Terminal

Certain functional aspects of the POS terminal 10 will now be described with reference to FIG. 11. FIG. 11 is a block diagram showing the functional aspects of the controller unit 100 of the POS terminal 10.

The controller unit 100 has an input unit 1001, a registration unit 1002, a payment processing unit 1003, and an output unit 1004. As the CPU 101 operates according to the control program stored in the ROM 102 or the memory unit 110, the controller unit 100 functions as the input unit 1001, the registration unit 1002, the payment processing unit 1003, and the output unit 1004. In other examples, these functions may be configured with hardware such as a dedicated circuit.

To the input unit 1001, various information is sent from the scanner 20, the touch panel 52, the card reader 54, the first weight measurement unit 71, the second weight measurement unit 81, and the like. For example, the merchandise code is sent to the input unit 1001 from the scanner 20.

Also, information based on a user operation on the touch panel 52 is sent to the input unit 1001. For example, transaction start information declaring the start of a transaction is sent to the input unit 1001. Also, registration completion information indicating that the merchandise registration in a transaction is completed is sent to the input unit 1001.

The registration unit 1002 executes the merchandise registration of each merchandise item to be purchased by a customer in response to operations by the customer. In other words, the registration unit 1002 registers information of the merchandise item identified by the merchandise identification information sent to the input unit 1001. Specifically, the registration unit 1002 reads out merchandise information from the merchandise master 112 based on the merchandise code sent to the input unit 1001. The registration unit 1002 then stores the merchandise information in the merchandise information unit 1031. The merchandise information includes the merchandise code, the merchandise name, the price, and the like.

The payment processing unit 1003 executes payment processing for the payment of the price of the merchandise items registered by the registration unit 1002. Specifically, the payment processing unit 1003 executes processing to calculate the total amount (transaction total amount) for the registered merchandise item(s), to calculate the amount of the change due, to display various information, to dispense a receipt, and the like. If the customer wishes a cashless settlement such as credit card settlement or two-dimensional code-based settlement, the payment processing unit 1003 can execute the necessary payment processing for the settlement.

The output unit 1004 outputs various information to the scanner 20, the printer 53, the change machine 55, the light emitting unit 571, the audio output unit 120, and the like. For example, if the transaction start information is sent to the input unit 1001, the output unit 1004 outputs an image pickup start signal to the scanner 20 giving an instruction to start image acquisition. If the registration completion information is sent to the input unit 1001, the output unit 1004 outputs an image pickup stop signal to the scanner 20 giving an instruction to stop image acquisition.

The output unit 1004 outputs a control signal to cause the audio output unit 120 to output a reporting sound, on completion of the merchandise registration of one merchandise item by the registration unit 1002. The output unit 1004 functions as a reporting element that causes the reporting unit (audio output unit 120) to report that the registration of the information of the merchandise item by the registration unit 1002 is complete. The audio output unit 120 can be provided in the scanner 20. In this case, the audio output unit 120 may output a reporting sound when the scanner 20 specifies the merchandise code.

### Functional Aspects of Scanner

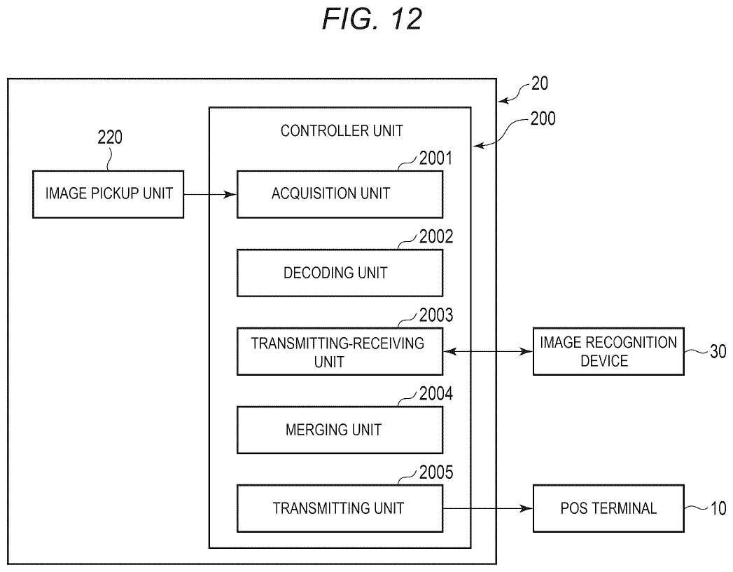

The functional aspects of the scanner 20 will now be described with reference to FIG. 12. FIG. 12 is a block diagram showing the functional aspects of the controller unit 200 of the scanner 20.

The controller unit 200 provides an acquisition unit 2001, a decoding unit 2002, a transmitting-receiving unit 2003, a merging unit 2004, and a transmitting unit 2005. As the CPU 201 operates according to the control program stored in the ROM 202 or the memory unit 210, the controller unit 200 provides the functions of the acquisition unit 2001, the decoding unit 2002, the transmitting-receiving unit 2003, the merging unit 2004, and the transmitting unit 2005. These functions may be implemented with hardware such as a dedicated circuit.

The acquisition unit 2001 acquires one frame image (picked-up image) as a merchandise image from a dynamic image picked up by the image pickup unit 220. The acquisition unit 2001 saves the acquired merchandise image in the RAM 203. For example, the acquisition unit 2001 acquires all or some of a plurality of frame images sequentially picked up by the image pickup unit 220, as candidates for the merchandise image, saves all or some of the frame images that are acquired into the RAM 203, and selects the merchandise image from among all or some of the frame images that are saved.

The acquisition unit 2001 acquires various other information. For example, the acquisition unit 2001 acquires an image pickup start signal and an image pickup stop signal from the POS terminal 10. By acquiring the image pickup start signal from the POS terminal 10, the acquisition unit 2001 detects that an operation by the customer is started (that is, in use by the customer). Also, by acquiring the image pickup stop signal from the POS terminal 10, the acquisition unit 2001 detects that the operation by the customer is complete (that is, not in use by the customer). If the acquisition unit 2001 acquires the image pickup start signal from the POS terminal 10, the image pickup unit 220 starts image pickup and the acquisition unit 2001 acquires a picked-up image picked up by the image pickup unit 220. If the acquisition unit 2001 acquires the image pickup stop signal from the POS terminal 10, the image pickup unit 220 stops the image pickup and the acquisition unit 2001 stops the acquisition of the picked-up image.

The decoding unit 2002 detects the merchandise barcode included in the merchandise image, which is the picked-up image acquired by the acquisition unit 2001, and extracts the merchandise barcode from the merchandise image. The decoding unit 2002 decodes the extracted merchandise barcode. The decoding unit 2002 acquires the merchandise code held by the merchandise barcode, as the result of decoding the merchandise barcode.

The transmitting-receiving unit 2003 transmits the merchandise image acquired by the acquisition unit 2001 to the image recognition device 30. The image recognition device 30 performs image recognition on the received merchandise image and transmits the result of image recognition (merchandise code of the merchandise item appearing in the merchandise image) to the scanner 20. The transmitting-receiving unit 2003 receives the result of image recognition transmitted from the image recognition device 30. The transmitting-receiving unit 2003 also transmits the result of decoding by the decoding unit 2002 (merchandise code held by the merchandise barcode) to the image recognition device 30.

The merging unit 2004 merges the result of decoding (merchandise code held by the merchandise barcode) with the result of image recognition (merchandise code of the merchandise item appearing in the merchandise image). That is, the merging unit 2004 acquires one merchandise code from the result of decoding and the result of image recognition. The result of merging includes the merchandise code held by the merchandise barcode included in the merchandise image or the merchandise code of the merchandise item appearing in the merchandise image.

If the result of decoding is not acquired, the merging unit 2004 defines the merchandise code that is the result of image recognition as the result of merging. The circumstance where the result of decoding is not acquired may be a case where the consumer does not correctly hold the merchandise barcode over the image pickup unit 220 of the scanner 20 or where the merchandise barcode is bent or folded unnaturally, or the like.

If both the result of decoding and the result of image recognition are acquired and the two results match each other, naturally, the merging unit 2004 defines the matching merchandise code as the result of merging. If both the result of decoding and the result of image recognition are acquired but the two results do not match each other, the merging unit 2004 defines the merchandise code that is the result of decoding, which is more reliable, as the result of merging.

The transmitting unit 2005 transmits the merchandise code that is the result of merging by the merging unit 2004 to the POS terminal 10 via the connection interface 221.

### Functional Configuration of Image Recognition Device

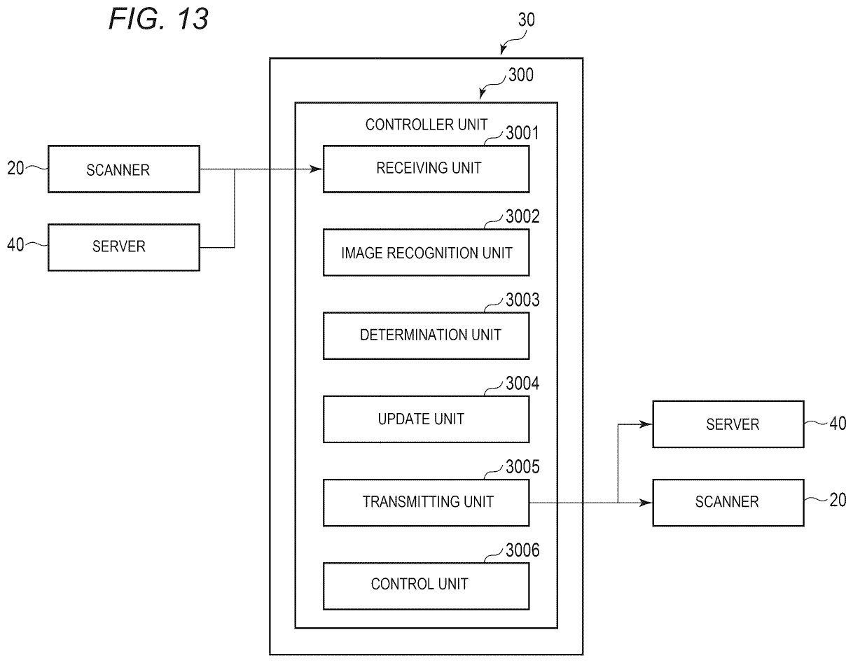

The function configuration of the image recognition device 30 will now be described with reference to FIG. 13. FIG. 13 is a block diagram showing the functional configuration of the controller unit 300 of the image recognition device 30.

The controller unit 300 provides a receiving unit (acquisition unit) 3001, an image recognition unit 3002, a determination unit 3003, an update unit 3004, a transmitting unit 3005, and a control unit 3006. As the CPU 301 operates according to the control program stored in the ROM 302 or the memory unit 310, the controller unit 300 provides the functions of the receiving unit 3001, the image recognition unit 3002, the determination unit 3003, the update unit 3004, the transmitting unit 3005, and the control unit 3006. These functions may be implemented with hardware such as a dedicated circuit.

The receiving unit 3001 receives the merchandise image, which is the picked-up image from the scanner 20, via the LAN interface 321. Specifically, the receiving unit 3001 acquires the picked-up image obtained in response to the operation of holding a merchandise item over the above-described image pickup unit 220 by the user (for example, 30 frames of images per one holding operation). The receiving unit 3001 saves the merchandise image, which is the received picked-up image, in the RAM 303.

The image recognition unit 3002 performs image recognition on the merchandise image by an image recognition function using the learned model 312. That is, the image recognition unit 3002 recognizes the merchandise item appearing in the picked-up image acquired by the receiving unit 3001. Specifically, the image recognition unit 3002 acquires feature data from the merchandise image, collates (compares) the acquired feature data with entries in the collation dictionary 313, and acquires a merchandise code associated with the feature data that is the most similar to the feature data from the merchandise image. The image recognition unit 3002 saves the acquired merchandise code in the RAM 303.

The transmitting unit 3005 transmits the merchandise code that is the result of image recognition by the image recognition unit 3002 to the transmitting-receiving unit 2003 of the scanner 20 via the LAN interface 321.

The determination unit 3003 determines whether the image recognition by the image recognition unit 3002 is successful. For example, if the difference between the acquired feature data and the closest matching dictionary feature data is less than some predetermined amount, the determination unit 3003 determines that the image recognition was successful. If the difference is equal to or greater the than predetermined amount, the determination unit 3003 determines that the image recognition was unsuccessful. If the determination unit 3003 determines that the image recognition is unsuccessful, the determination unit 3003 determines that the merchandise image on which image recognition was unsuccessfully performed is a merchandise image to be used for additional learning.

The receiving unit 3001 also receives the merchandise code that is the result of decoding from the scanner 20 via the LAN interface 321. The receiving unit 3001 saves the received merchandise code in the RAM 303.

If the determination unit 3003 determines that the merchandise image is to be used for additional learning, the transmitting unit 3005 transmits the merchandise image and the corresponding merchandise code to the server 40 via the LAN interface 321.

The control unit 3006 controls merchandise registration and dictionary generation and provides the various functions described below.

For example, the control unit 3006 can update the currently stored collation dictionary 313 using only the picked-up images where no hand appears out of all the picked-up images in which a merchandise item was recognized by the image recognition unit 3002. With this function, merchandise registration and dictionary generation using a picked-up image where a hand appears will not be performed, and merchandise registration and dictionary update based on only those images without a hand therein can be automatically performed without the user or the operator having to perform any particular operation. Therefore, proper merchandise registration can be performed without much time and effort on the part of the user/operator and a high-quality dictionary for image recognition (package recognition) can be generated.

The control unit 3006 also assigns identification information to a user operation of holding one merchandise item, as a unit operation, and saving a picked-up image of the merchandise item in which no hand appears, on a per identification number basis of the user operation. With this function, a picked-up image where a hand appears can be prevented for being used to update the dictionary, every time the user operation of holding a merchandise item is performed. Therefore, the quality of the dictionary can be securely improved.

The control unit 3006 also assigns a ground-truth label to the picked-up image of the merchandise item where no hand appears. The ground truth label is obtained from the result of decoding the merchandise barcode on the merchandise item. The control unit 3006 then saves this picked-up image of the merchandise item. With this function, information in which a ground-truth label is assigned to the picked-up image of the merchandise item can be easily generated, and a dictionary representing a clear relationship between the picked-up image of the merchandise item (in which no hand appears) and its ground-truth label can be generated.

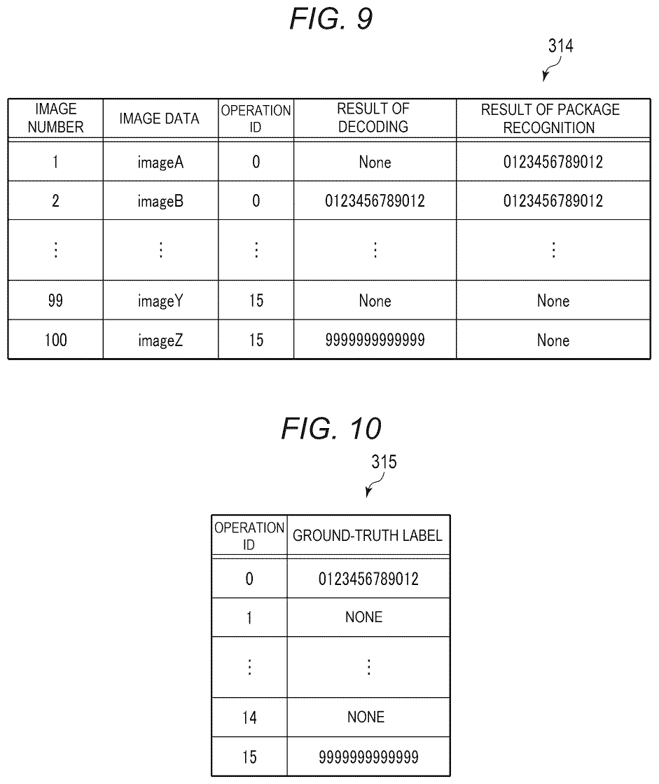

The control unit 3006 also stores in a memory, on a per picked-up image basis, image management information establishing the correspondence between the identification information of the image, the data of the image, the identification information of the operation, the result of decoding the merchandise barcode, and the result of image recognition on the image (the result of package recognition). FIG. 9 shows an example of the image management information with a relationship between various information on a per picked-up image basis. As shown in FIG. 9, for f example, the image management information 314 establishing the correspondence between “image number” (entries: 1, 2, . . . 99, 100), “image data” (entries: image A, image B, . . . image Y, image Z), “operation ID” (entries: 0, 0, . . . 15, 15), “result of decoding” (entries: None, 0123456789012, . . . None, 9999999999999), and “result of package recognition” (entries: 0123456789012, 0123456789012, . . . None, None) on a per picked-up image basis may be generated and stored in the memory unit 310. Thus, the relationship between various correlated information can be clarified on a per picked-up image basis (that is, for each individual picked-up image).

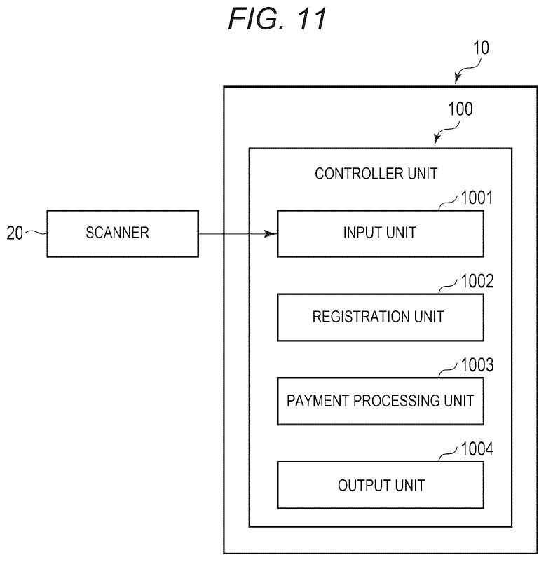

The control unit 3006 also generates ground-truth label information representing a ground-truth label on a per operation identification number basis (that is, for each individual identification operation/attempt) and stores the ground-truth label information in a memory, for the management (tracking) of the ground-truth labels. FIG. 10 shows an example of the ground-truth label information representing the relationship between the operation identification number and the ground-truth label. As shown in FIG. 10, the ground-truth label information 315 includes a “ground-truth label” (entries: 0123456789012, None, . . . None, 9999999999999) corresponding respectively to “operation ID” (entries: 0, 0, . . . 14, 15) is generated. Thus, information representing a clear relationship between the operation identification number and a ground-truth label can be generated.

The control unit 3006 also compares a frame image with the frame image picked up one frame before, determining whether an object has moved out of the angle of view (imaging range) or moved into the angle of view from the state in which nothing appears in the angle of view, and thus can determine whether the two consecutive images (frames) correspond to the same holding operation (event). With this, whether frames correspond to the same holding operation or correspond to different holding operations s can be accurately distinguished. Therefore, the quality of the dictionary can be improved further.

The server 40 performs additional learning of the learned model 412 for merchandise image recognition, using the received merchandise image and merchandise code, and updates the learned model 412 and the collation dictionary 413. The server 40 transmits the updated learned model 412 and the updated collation dictionary 413 to the receiving unit 3001 of the image recognition device 30 via the LAN interface 321.

The receiving unit 3001 receives the updated learned model 412 and the updated collation dictionary 413 from the server 40 via the LAN interface 321. The receiving unit 3001 saves the updated learned model 412 and the updated collation dictionary 413 that are received, in the RAM 303.

The update unit 3004 updates the learned model 312 currently held in the memory unit 310, with the updated learned model 412 that is received. The image recognition device 30 updates the collation dictionary 313 currently held in the memory unit 310, with the updated collation dictionary 413 that is received.

### Functional Configuration of Server

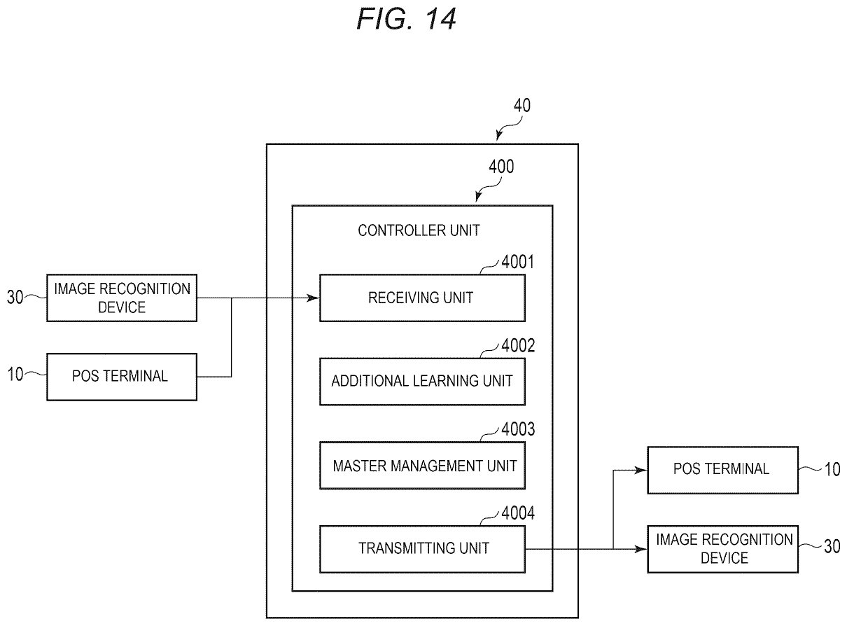

The functional configuration of the server 40 will now be described with reference to FIG. 14. FIG. 14 is a block diagram showing the functional configuration of the controller unit 400 of the server 40.

The controller unit 400 provides a receiving unit 4001, an additional learning unit 4002, a master management unit 4003, and a transmitting unit 4004. As the CPU 401 operates according to the control program stored in the ROM 402 or the memory unit 410, the controller unit 400 provides the functions of the receiving unit 4001, the additional learning unit 4002, the master management unit 4003, and the transmitting unit 4004. These functions may be implemented with hardware such as a dedicated circuit.

The receiving unit 4001 receives the merchandise image for additional learning and a merchandise code from the image recognition device 30 via the communication unit 421. The receiving unit 4001 saves the received merchandise image and merchandise code in the RAM 403. The receiving unit 4001 may save, collect, and store the received merchandise image in the RAM 403 or the memory unit 410, for example, as a merchandise image to analyze the state (event) of image recognition by the image recognition device 30.

The additional learning unit 4002 performs additional learning for the learned model 412 in the memory unit 410 at an appropriate time, for example, when the merchandise images for additional learning and merchandise codes have been collected and stored in certain arbitrary total numbers. The additional learning unit 4002 thus updates the learned model 412. The additional learning unit 4002 also updates the collation dictionary 413 held in the memory unit 410 along with the additional learning of the learned model 412.

The transmitting unit 4004 transmits the updated learned model 412 and collation dictionary 413 that are updated by the additional learning unit 4002, for example, as an image file or a compressed file, to the receiving unit 3001 of the image recognition device 30 via the communication unit 421.

The receiving unit 4001 also receives the payment processing information from the POS terminal 10 via the communication unit 421. The receiving unit 4001 saves the received payment processing information in the RAM 403.

The master management unit 4003 manages the merchandise master 414 held in the memory unit 410 based on the received payment processing information. For example, the merchandise master 414 includes a store code identifying a store and information such as the merchandise master 112 on a per store code basis. The merchandise master 414 may also include information as to whether the merchandise item with the merchandise code is available or unavailable and the number of the remaining merchandise items (stock level) on a per store code basis (individual store basis). The master management unit 4003 updates the merchandise master 414 information, such as the number of the remaining merchandise items with a particular merchandise code, based on the received payment processing information.

The transmitting unit 4004 transmits the merchandise master 112 suitable for each store to the POS terminal 10 of the store via the communication unit 421, based on the merchandise master 414 updated by the master management unit 4003.

### Operations of Scanner

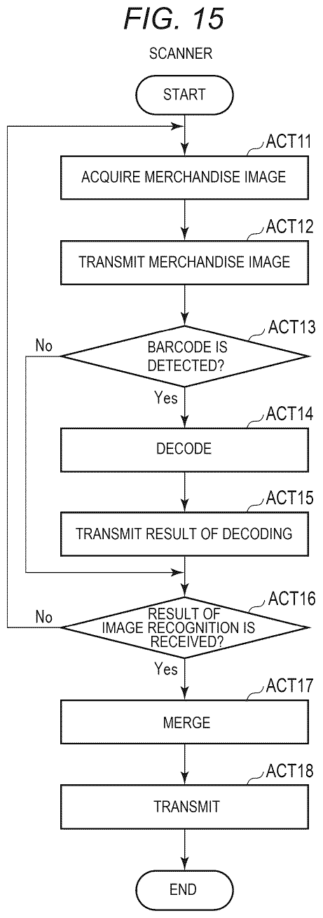

The operations of the scanner 20 will now be described with reference to FIG. 15. FIG. 15 is a flowchart of operations of the scanner 20 in the embodiment. The operations of the scanner 20 are performed by each unit of the scanner 20 under the control of the controller unit 200 executing the control program 211.

In ACT 11, the scanner 20 acquires a merchandise image (a picked-up image) from a dynamic (e.g., video) image picked up by the image pickup unit 220. For example, the scanner 20 first saves all or some of the frame images that are sequentially picked up by the image pickup unit 220 in the RAM 203, and treats these individual frame images as candidates for a merchandise image. Subsequently, the scanner 20 selects one frame image from among the plurality 41 frame images held in the RAM 203 and O identifies the selected frame image as a merchandise image. The scanner 20 also assigns an identification code to the merchandise image to identify the merchandise image. In the description below, for the sake of convenience, it is assumed that the merchandise image includes the identification code assigned thereto.

In ACT 12, the scanner 20 transmits the merchandise image to the image recognition device 30 via the LAN, for example, by TCP communication.

In ACT 13, the scanner 20 performs detection of a merchandise barcode from the merchandise image. In other words, the scanner 20 determines whether a merchandise barcode is picked up in the merchandise image.

If a merchandise barcode is detected in ACT 13 (Yes in ACT 13), the scanner 20 in ACT 14 extracts and decodes the detected merchandise barcode and acquires a merchandise code held by the merchandise barcode, as the result of decoding. The scanner 20 saves the acquired merchandise code in the RAM 203.

In ACT 15, the scanner 20 transmits the merchandise code that is the result of decoding (the merchandise code encoded in the merchandise barcode) to the image recognition device 30. Since the operations in ACT 14 and ACT 15 are operations performed when a merchandise barcode is detected in ACT 13, the scanner 20 need not transmit a merchandise code that is the result of decoding if the merchandise code is otherwise obtained.

In ACT 16, the scanner 20 checks whether the result of image (object) recognition on the merchandise image has been received from the image recognition device 30. If the result of image recognition is received (Yes in ACT 16), the scanner 20 saves the received result of image recognition in the RAM 203. The scanner 20 may identify the merchandise image corresponding to the result of image recognition based on the identification code received with the result of image recognition. Subsequently, the scanner 20 shifts to a merging operation in ACT 17.

If a merchandise barcode is not detected in ACT 13 (No in ACT 13), the scanner 20 skips the operations in ACT 14 and ACT 15 and shifts to the operation of checking for the reception of the result of image recognition in ACT 16.

If the result of image recognition is not received in ACT 16 (No in ACT 16), the scanner 20 repeats the operations in ACT 11 and ACTS 13 to 15. In this case, the image recognition device 30 does not need a new merchandise image process and therefore the transmission of the merchandise image in ACT 12 is omitted. That is, the scanner 20 continues a series of regular operations, that is, the acquisition of a merchandise image in ACT 11, the detection of a merchandise barcode in ACT 13, the decoding in ACT 14, and the transmission of a merchandise code that is the result of decoding in ACT 15, until the result of image recognition is received from the image recognition device 30.

In ACT 17, the scanner 20 merges the result of decoding with the result of image recognition. That is, the scanner 20 acquires the one merchandise code considered to be the most correct between the result of decoding and the result of image recognition if the results differ.

If a decoding result is not acquired, a merchandise code from the image recognition can be set as the result of merging (the merged result). A circumstance where the decoding result is not acquired may be when the consumer does not correctly hold the merchandise barcode over the image pickup unit 220 or the merchandise barcode has been bent, folded, or otherwise marred.

If both a decoding result and an image recognition result are acquired, the scanner 20 compares the results. If the results match each other, the scanner 20 sets the matching merchandise code as the merged result. If results do not match each other, the scanner 20 set the merchandise code from the decoding result, which is considered more reliable, as the merged result.

In ACT 18, the scanner 20 transmits the merchandise code that is the result of merging (the one merchandise code considered to be the most correct) to the POS terminal 10.

### Operations of Image Recognition Device

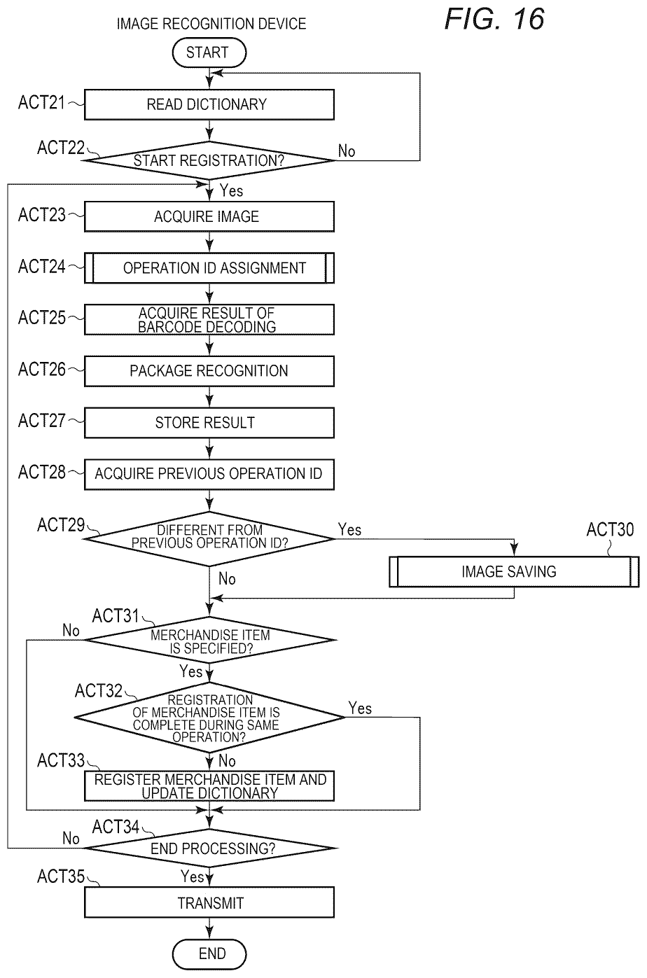

The operations of the image recognition device 30 will now be described with reference to FIG. 16. FIG. 16 is a flowchart of operations of the image recognition device 30 in the embodiment. The operations of the image recognition device 30 are performed by each unit of the image recognition device 30 under the control of the controller unit 300 executing the control program 311.

In ACT 21, the image recognition device 30 reads the collation dictionary 313 used for image recognition (package recognition). In the collation dictionary 313, feature data corresponding to the pictorial pattern of the merchandise package is saved.

In ACT 22, the image recognition device 30 starts the processing of merchandise registration. In ACT 23, the image recognition device 30 acquires an image picked up by the image pickup unit 220 installed in the scanner 20.

In ACT 24, the image recognition device 30 assigns an operation ID to the acquired image. As will be described in detail later, the same operation ID is assigned to individual frames acquired when the user scans the same merchandise item.

In ACT 25, the image recognition device 30 acquires the barcode decoding result from the scanner 20. In ACT 26, the image recognition device 30 acquires the picked-up image (merchandise image) from the scanner 20 and performs the recognition (package recognition) on the acquired picked-up image.

A barcode decoding result requires detecting an area of a one-dimensional or two-dimensional barcode or the like and then decoding the barcode. In a package recognition, a merchandise area may be detected and the recognition over the detected area is performed. To detect the merchandise area, any method may be used, such as deep learning using CNN (convolutional neural network), which is a technique suitable for image recognition, or graph cuts. Also, for the package recognition, any method may be used, such as deep learning using CNN, or feature point matching. Although the structure of the dictionary read in ACT 21 changes depending on the recognition technique, the structure is not particularly limited, provided that the merchandise item can be specified based on the pictorial pattern of the merchandise package. For example, the dictionary may be divided into a plurality of files. The processing in ACTs 24 to 26 may be performed in parallel.

In ACT 27, the image recognition device 30 stores the barcode decoding result and the package recognition result in the memory unit 310. The image recognition device 30 transmits information representing the package recognition result to the scanner 20 side.

The information stored in the memory unit 310 is stored in the memory unit 310 as the image management information 314 establishing the correspondence between “image number”, “image data”, “operation ID”, “result of decoding”, and “result of package recognition” on a per picked-up image basis, for example, as described with reference to FIG. 9.

In ACT 28, the image recognition device 30 acquires the previous operation ID (one frame before). In ACT 29, the image recognition device 30 determines whether the operation ID is different from the previous operation ID.

If the operation ID is different from the previous operation ID (Yes in ACT 29), the image recognition device 30 in ACT 30 saves the corresponding image in the RAM 303. If the ID is the same (No in ACT 29), no particular image is saved.

The subsequent operations include operations on the scanner 20 side and operations on the POS terminal 10 side. These operations are closely related to the operations on the image recognition device 30 side. Therefore, these operations other than the operations of the image recognition device 30 will be described as well. In the description below, these operations will be described as operations of the merchandise information registration system RS.

In ACT 31, the merchandise information registration system RS determines whether the merchandise item has been specified (identified). If the merchandise item is not specified (No in ACT 31), the merchandise information registration system RS proceeds to ACT 34. If the merchandise item is specified (Yes in ACT 31), the merchandise information registration system RS proceeds to ACT 32.

In ACT 32, the merchandise information registration system RS determines whether the registration of the merchandise item in the same operation (that is, one scan attempt) has already been completed. If the registration of the merchandise item has already been completed (Yes in ACT 32), the merchandise information registration system RS proceeds to ACT 34 without performing another registration of the merchandise item. If the registration of the merchandise item has not been completed (No in ACT 32), the merchandise information registration system RS proceeds to ACT 33.

In ACT 33, the merchandise information registration system RS registers the merchandise item on the scanner 20 side and updates the dictionary on the image recognition device 30 side.

In ACT 34, the merchandise information registration system RS determines whether to continue the processing or end the processing. If the processing is to continue (No in ACT 34), the processing is repeated from ACT 23 onward. If the processing is to end (Yes in ACT 34), the merchandise information registration system RS proceeds to ACT 35.

In ACT 35, the merchandise information registration system RS transmits the result of a dictionary update on the image recognition device 30 side to the server 40.

The series of processes thus ends.

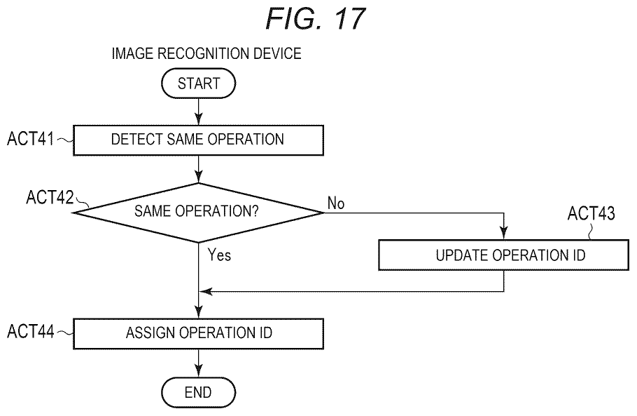

A specific example of the processing of “operation ID assignment” in ACT 24 (FIG. 16) will now be described with reference to FIG. 17. FIG. 17 is a flowchart showing a specific example of the processing of “operation ID assignment” in ACT 24. In this example, the initial value of the operation ID is 0.

In ACT 41, the image recognition device 30 performs a detection to determine if the same operation is on-going. Specifically, the image recognition device 30 compares one frame image to a frame image picked up one frame before to detect whether an object has moved out of the angle of view or whether an object has moved into the angle of view from a state in which nothing appeared in the angle of view, and thus can determines whether the two consecutive frame images correspond to the same holding operation (same merchandise item registration attempt).

Whether an object is moved out of the angle of view or is moved into the angle of view can be determined, for example, by taking an image difference and determining whether there is a large change. Alternatively, the operation may be determined as the same operation if an object is still present within some predetermined range from the scanner 20 using a distance sensor or the like.

If the two frames are not from the same operation, that is, not from the same holding operation (No in ACT 42), the image recognition device 30 updates the operation ID in ACT 43 and proceeds to ACT 44. If the operation is the same holding operation (Yes in ACT 42), the image recognition device 30 proceeds to ACT 44 without updating the operation ID to a new (next) operation ID.

In ACT 44, the image recognition device 30 assigns an operation ID to the corresponding image and ends the series of processes.

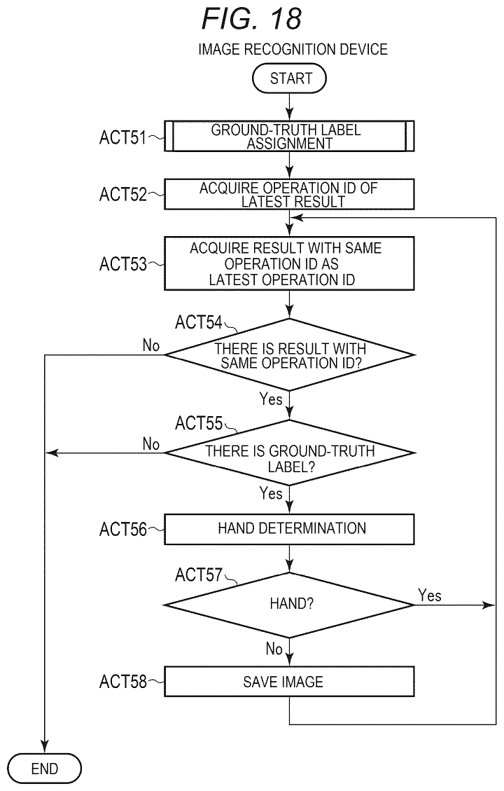

A specific example of the processing of “image saving” in ACT 30 (FIG. 16) will now be described with reference to FIG. 18. FIG. 18 is a flowchart showing a specific example of the processing of “image saving” in ACT 30.

In ACT 51, the image recognition device 30 performs the assignment of a ground-truth label to the corresponding image.

In ACT 52, the image recognition device 30 acquires the operation ID of the latest (most recent) result of the individual results that have been stored (the results of decoding, results of package recognition). The latest result can be determined based on a time point comparison or, alternatively, the last is stored result in series can be taken as the most recent.

In ACT 53, the image recognition device 30 acquires a result (next result) having the same operation ID as the operation ID acquired in ACT 52 from among the individual results that are stored.

In ACT 54, the image recognition device 30 determines whether there is another result having the same operation ID. If there is no other result having the same operation ID (No in ACT 54), the image recognition device 30 ends the series of processes. If there is another result having the same operation ID (Yes in ACT 54), the image recognition device 30 proceeds to ACT 55.

In ACT 55, the image recognition device 30 determines whether the other result having the same operation ID has a ground-truth label associated therewith. If there is no ground-truth label (No in ACT 55) associated with any other result having the same operation ID, the image recognition device 30 ends the series of processes. If there is a ground-truth label (Yes in ACT 55), the image recognition device 30 proceeds to ACT 56.

In ACT 56, the image recognition device 30 performs a hand determination. Specifically, the image recognition device 30 determines whether a hand appears in an object area in the image, for example, using a CNN or the like. The image recognition device 30 may determine that an image which includes a hand area with a high proportion is an image of a hand, using a semantic segmentation technique for detecting an object at pixel level.

If a hand appears in the image (Yes in ACT 57), the image recognition device 30 returns to ACT 53 and repeats the processing until there is no other stored result having the same operation ID. If no hand appears (No in ACT 57), the image recognition device 30 proceeds to ACT 58.

In ACT 58, the image recognition device 30 saves the image in which no hand appears. f the image is saved in combination with the acquired ground-truth label, the image can be used for the generation of a dictionary entry without additional work.

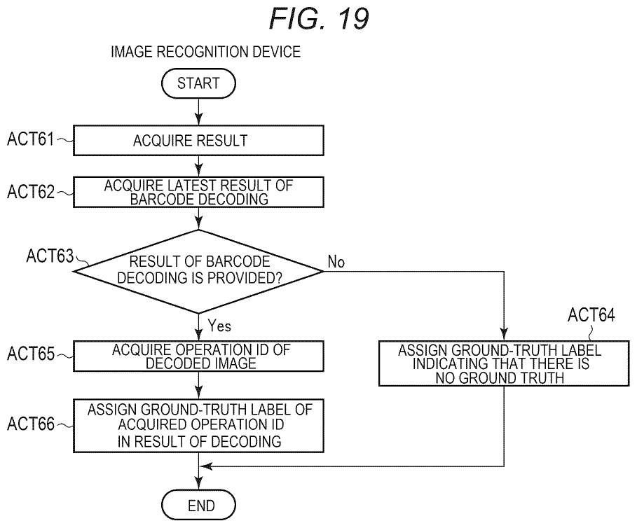

A specific example of the processing of “ground-truth label assignment” in ACT 51 (FIG. 18) will now be described with reference to FIG. 19. FIG. 19 is a flowchart showing a specific example of the processing of “ground-truth label assignment” in ACT 51.

In ACT 61, the image recognition device 30 acquires the result stored in ACT 27.

In ACT 62, the image recognition device 30 acquires the latest result of barcode decoding.

In ACT 63, the image recognition device 30 determines whether the barcode decoding result has been provided. If the barcode decoding result is not provided (No in ACT 63), the image recognition device 30 in ACT 64 assigns information representing “no ground truth” to the operation ID, and ends the series of processing. If a barcode decoding result is provided (Yes in ACT 63), the image recognition device 30 in ACT 65 acquires the operation ID of the successfully decoded image. In ACT 66, the image recognition device 30 assigns the ground-truth label to the acquired operation ID, for example, as described with reference to FIG. 10. The image recognition device 30 then ends the series of processes.

### Summary

According to an embodiment, the control unit 3006 can update the currently held collation dictionary 313, using only a picked-up image where no hand appears, of individual picked-up images where a merchandise item is recognized by the image recognition unit 3002. Thus, merchandise registration and dictionary generation using a picked-up image where a hand appears are not performed, and merchandise registration and dictionary generation based on only a picked-up image where no hand appears are automatically performed without the user or the operator having to perform any particular operation. Therefore, proper merchandise registration can be performed without much time and effort and a high-quality dictionary for image recognition (package recognition) can be generated.

According to the embodiment, the control unit 3006 can assign identification information to an operation of holding one merchandise item by the user, as a unit operation, and save a picked-up image of the merchandise item where no hand appears, on a per identification number basis of the operation. Thus, a picked-up image where a hand appears can be prevented for being used to update the dictionary, every time the operation of holding a merchandise item is performed. Therefore, the quality of the dictionary can be securely improved.

According to the embodiment, the control unit 3006 can assign a ground-truth label obtained from decoding the merchandise barcode to the picked-up image of the merchandise item where no hand appears, and then save this picked-up image. Thus, information in which the ground-truth label is assigned to the picked-up image of the merchandise item where no hand appears can be easily generated, and a dictionary representing a clear relationship between the picked-up image of the merchandise item where no hand appears and the ground-truth label can be generated.

According to this embodiment, the control unit 3006 can store in a memory, for each picked-up image, image management information establishing the correspondence between the identification information of the image, the data of the image, the operation identification information, the result of decoding the merchandise barcode, and the result of image recognition on the image (the result of package recognition). Thus, the relationship between various correlated information can be clarified on a per picked-up image basis.

According to this embodiment, the control unit 3006 can generate ground-truth label information providing a ground-truth label on a per operation identification number basis, and store the ground-truth label information in a memory for the management of the ground-truth labels. Thus, information representing a clear relationship between. the operation identification number and a ground-truth label can be generated.

The control unit 3006 can also compare one frame image with the frame image picked up one frame before so as to determine whether an object has been moved out of the imaging angle of view (imaging range) or whether an object has been moved into the imaging angle of view after a state in which nothing (no object) appears in the imaging angle of view, and thus determine whether the two frame images correspond to the same holding operation. Thus, whether the frame images in sequence correspond to the same holding operation or correspond to different holding operations can be accurately distinguished. Therefore, the quality of the dictionary can be improved further.

### Other Matters

The control programs executed by the POS terminal 10, the scanner 20, the image recognition device 30, and the server 40 in the above embodiment may be provided in a non-transitory computer-readable recording medium such as a CD-ROM. The control programs executed by the POS terminal 10, the scanner 20, the image recognition device 30, and the server 40 in the above embodiment may be stored on a computer connected to a network, such as the internet, and provided by being downloaded, accessed, or distributed via the network.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A merchandise information processing device, comprising:
a communication interface connectable to a product scanner; and
a control unit configured to:
receive an image from the product scanner obtained when a user holds a merchandise item in front of an image pickup unit of the product scanner in a scanning operation;
process the image to obtain a merchandise code for the merchandise item in the image by object recognition;
process the image to determine if a hand of the user appears in the image; and
save the image to update a dictionary file only if the merchandise code obtained by the object recognition does not match a merchandise code received from the product scanner in association with the image and the hand of the user is determined not to be in the image.

2. The merchandise information processing device according to claim 1, wherein the image is one frame in a series of frames received from the product scanner for the same scanning operation.

3. The merchandise information processing device according to claim 1, wherein the control unit is further configured to:
assign operation identification information to images acquired during the same scanning operation of the merchandise item.

4. The merchandise information processing device according to claim 3, wherein the control unit is further configured to:
assign a ground-truth label to the saved image according to the merchandise code from the product scanner.

5. The merchandise information processing device according to claim 3, wherein the control unit is further configured to:
save each image received from the product scanner, each image being associated with image identification information, image data, operation identification information, a merchandise barcode decoding result, and an image recognition result.

6. The merchandise information processing device according to claim 1, wherein
the image is one frame in a series of frames received from the product scanner, and
the control unit is further configured to:
compare the image to another image in the series to determine whether an object has moved out of an imaging range of the image pickup unit or whether an object has moved into the imaging range after no object appeared in the imaging range, and
determine whether the two images correspond to a same scanning operation based on the comparison of the two images.

7. The merchandise information processing device according to claim 1, wherein the control unit performs the object recognition on the image.

8. The merchandise information processing device according to claim 1, wherein the control unit sends the saved image to a server to update the dictionary file.

9. A merchandise information processing system, comprising:
a product scanner with an image pickup unit;
an image recognition device connected to the product scanner, the image recognition device including:
a communication interface connected to the product scanner; and
a control unit configured to:
receive image from the product scanner obtained when a user holds a merchandise item in front of the image pickup unit in a scanning operation;
process the image to obtain a merchandise code for the merchandise item in the image by object recognition;
process the image to determine if a hand of the user appears in the image; and
save the image to update a dictionary file only if the merchandise code obtained by the object recognition does not match a merchandise code received from the product scanner in association with the image and the hand of the user is determined not to be in the image.

10. The merchandise information processing system according to claim 9, wherein the image is one frame in a series of frames received from the product scanner for the same scanning operation.

11. The merchandise information processing system according to claim 9, wherein the control unit is further configured to:
assign operation identification information to images acquired during the same scanning operation of the merchandise item.

12. The merchandise information processing system according to claim 11, wherein the control unit is further configured to:
assign a ground-truth label to the saved image according to the merchandise code from the product scanner.

13. The merchandise information processing system according to claim 11, wherein the control unit is further configured to:
save each image received from the product scanner, each image being associated with image identification information, image data, operation identification information, a merchandise barcode decoding result, and an image recognition result.

14. The merchandise information processing system according to claim 9, wherein
the image is one frame in a series of frames received from the product scanner, and
the control unit is further configured to:
compare the image to another image in the series to determine whether an object has moved out of an imaging range of the image pickup unit or whether an object has moved into the imaging range after no object appeared in the imaging range, and
determine whether the two images correspond to a same scanning operation based on the comparison of the two images.

15. The merchandise information processing system according to claim 9, wherein the control unit performs the object recognition on the image.

16. The merchandise information processing system according to claim 9, further comprising:
a server storing one or more dictionary files, wherein
the control unit sends the saved image to the server to update the dictionary file.

17. A merchandise information processing method, comprising:
receiving an image from a product scanner, the image being obtained when a user holds a merchandise item in front of an image pickup unit of the product scanner in a scanning operation;
processing the image to obtain a merchandise code for the merchandise item in the image by object recognition;
processing the image to determine if a hand of the user appears in the image; and
saving the image to update a dictionary file only if the merchandise code obtained by the object recognition does not match a merchandise code received from the product scanner in association with the image and the hand of the user is determined not to be in the image.

18. The merchandise information processing method according to claim 17, wherein the image is one frame in a series of frames received from the product scanner for the same scanning operation.

19. The merchandise information processing method according to claim 17, further comprising:
assigning operation identification information to images acquired during the same scanning operation of the merchandise item.

20. The merchandise information processing method according to claim 19, further comprising:
assigning a ground-truth label to the saved image according to the merchandise code from the product scanner.
